(19) United States
(12) Patent Application Publication
(10) Pub. No.: US 2006/0069459 A1
(43) Pub. Date: Mar. 30, 2006

(54) Industrial control and monitoring system status visualization method and system

(76) Inventor: Kevin A. Retlich, Wauwatosa, WI (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 10/954,128

(22) Filed: Sep. 29, 2004

(51) Int. Cl. G06F 19/00; G05B 13/02; G05B 15/02

(52) U.S. Cl. 700/108; 700/9; 700/28

(57) ABSTRACT

Embodiments of the present invention relate to a system and method of industrial control and monitoring status visualization. In accordance with embodiments of the present techniques, a system view for a networked system may be provided comprising an expandable component tree. The expandable component tree may comprise at least one parent icon and at least one child icon, wherein the parent icon is expandable to reveal the child icon and the child icon is associated with a networked component of the networked system. A first dynamic graphic may be associated with the child icon, wherein the first dynamic graphic is adapted to change based on changes relating to a status of the networked component. Further, embodiments of the present techniques comprise a sorting system adapted to pass the first dynamic graphic up the expandable component tree based on a configuration of the sorting system, to a second dynamic graphic associated with the parent icon.

### BACKGROUND

The present invention relates generally to the field of networked control and monitoring systems, such as those used in industrial and commercial settings. More particularly, the invention relates to techniques for visualizing the status of associated equipment and systems in an efficient and intuitive manner.

Control and monitoring systems may include large numbers of components at disparate locations, interconnected in many different ways, depending upon the type of process being carried out and the type of oversight desired. Such systems may include, for example, motors, valves, material handling equipment (e.g., conveyors, stackers, pumps, etc.) to mention only a few. Moreover, the equipment will typically be networked in groups of components by function and/or location. The resulting overall structure can be extremely complex, making oversight and troubleshooting the equipment, in the event of faults or needed maintenance, very problematical.

Networked control and monitoring systems typically include system layout graphics that illustrate characteristics relating to networked components within a particular system. For example, a system layout view may comprise graphics that dynamically illustrate metrics and parameters relating to motor controllers, pressure sensors, drives, relays, protection devices, switch gear, and the like. In a typical industrial automation application, a system view may be configured to portray components within the application using graphics linked to dynamic data and arranged in relation to the actual physical location of the networked components. For example, a control and monitoring system may present data collected from the network on a computerized system layout view as text along with associated graphics that are positioned in accordance with a piping and instrument diagram (P&ID).

Typical networked control and monitoring systems include a wide range of components designed to carryout specific functions individually and in cooperation. For example, devices such as motor controllers, pressure sensors, drives, relays, protection devices, switch gear, and the like are often used to regulate application of electrical power to loads (e.g., electric motors). Motor control centers, for example, include many such devices, which are operated in accordance with sensed operational parameters, operator-induced input signals and settings, and preprogrammed routines. In a typical application, the components are installed at a control site and are linked to controlled and sensing devices. The configuration and programming for the components may be provided by computers, programmable logic controllers, or other logic devices. System layout graphics often facilitate such configuration and programming. Further, system layout graphics may facilitate observation and operation of systems comprising components such as those discussed above.

Where a large number of components are built into a system, their identification is often relatively rudimentary, relying upon drawings, “as-built” representations, and nameplate information (typically read directly from the equipment by operators or technicians). Both during installation and subsequent maintenance or servicing, individual components are separately identified, often visually, and must be manually associated with data collected via a control or monitoring network, where available. Where changes are made to a system after its installation, the reliability of drawings, system layouts, and the like, may become suspect, and considerable time may be lost in evaluating the actual physical configuration of the system to identify both the desired function of the components and their physical location. For example, system layout graphics on control system monitors may require revision because of equipment replacement, removal, and/or exchange.

Another problem typically associated with systems comprising a large number of components relates to user identification of problem areas. The user may be overwhelmed with visual input or may find it necessary to excessively search or scan for indications of trouble. For example, a large system may be divided into several different areas, each area comprising a number of components. The system components for each area may be represented in different locations on a single screen or on a plurality of different screens. Thus, if a particular component fails and such failure is indicated by a graphics change, it may be difficult for a user to discern the precise location of the problem. The user may be overwhelmed by the quantity of graphics or may find it necessary to meticulously search through the graphics to identify the problem.

There is a need in the art for an improved technique for revising control system graphics, illustrating networked components and component characteristics, identifying networked components, and identifying characteristics relating to networked components. There is a particular need for a technique, which would facilitate the identification of the components along with their function, status, and physical location in a system, both at the time of installation, and following any changes made to the system during its life. Similarly, it is desirable to have an improved method of configuring control system graphics to reflect such system characteristics. For example, there is a particular need for an improved technique to illustrate status changes in system components, operational similarities between components, and the physical location of certain components within the system.

### BRIEF DESCRIPTION

Embodiments of the present invention relate to an industrial control and monitoring system status visualization method and system. For example, in one embodiment of the present techniques, a system view for a networked system comprises an expandable component tree that represents various network devices. The expandable component tree may comprise at least one parent icon and at least one child icon, wherein the parent icon is expandable to reveal the child icon and the child icon is associated with a networked device. While expandable component trees in accordance with the present techniques may look and perform like a conventional element tree, such embodiments comprise features not available in existing interfaces of this type. For example, component icons in the expandable component tree may comprise dynamic component graphics that are linked or mapped to parameters in a database of component characteristics. Further, component graphics may illustrate dynamic characteristics associated with each component or set of components in near real time. Further, each component icon may be programmable. For example, a configurable sorting system may be incorporated into embodiments of the present techniques. In some embodiments, such sorting systems may be adapted to pass the first dynamic graphic up the expandable component tree based on a configuration of the sorting system, to a second dynamic graphic associated with the parent icon.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an exemplary control and monitoring system incorporating a component status visualization technique in accordance with embodiments of the present invention;

FIG. 2 is a block diagram illustrating various components in an exemplary implementation of a status visualization technique in accordance with embodiments of the present invention;

FIG. 3 is a block diagram illustrating an exemplary component in accordance with embodiments of the present invention;

FIG. 4 illustrates a control and monitoring system view in accordance with embodiments of the present invention; and

FIGS. 5 and 6 illustrate alternative system views in accordance with embodiments of the present invention.

### DETAILED DESCRIPTION

Embodiments of the present invention relate generally to the field of networked control and monitoring systems, such as those used in industrial automation. It should be noted, however, that the invention is not intended to be limited to this or any particular setting. More particularly, embodiments of the present invention relate to a system and method for providing system views of such control and monitoring systems. A system view may be described as a graphical interface that provides a user with information relating to a networked system through a graphical display. For example, a system view may comprise graphics displayed on a computer monitor that provide an interactive, real time, display of input data from external devices. System views, in accordance with the present invention, may include various different dynamic data and graphic presentations relating to networked component characteristics. For example, a system view may illustrate aspects relating to a system such as the relative location of components within a process (e.g., process view), equipment types and listings associated with system components (e.g., an equipment view), the position or designation and interrelationships of components within a network (e.g., a network view), and other relevant component input. Specifically, embodiments of the present invention relate to system views that facilitate rapid and efficient access to networked component data. Additionally, embodiments of the present invention relate to techniques for building and revising such system views to illustrate component characteristics. For example, in some embodiments of the present invention, system views may be configured to illustrate the status of particular components along with their physical, functional or network relationship to other devices that are inside or outside of the network.

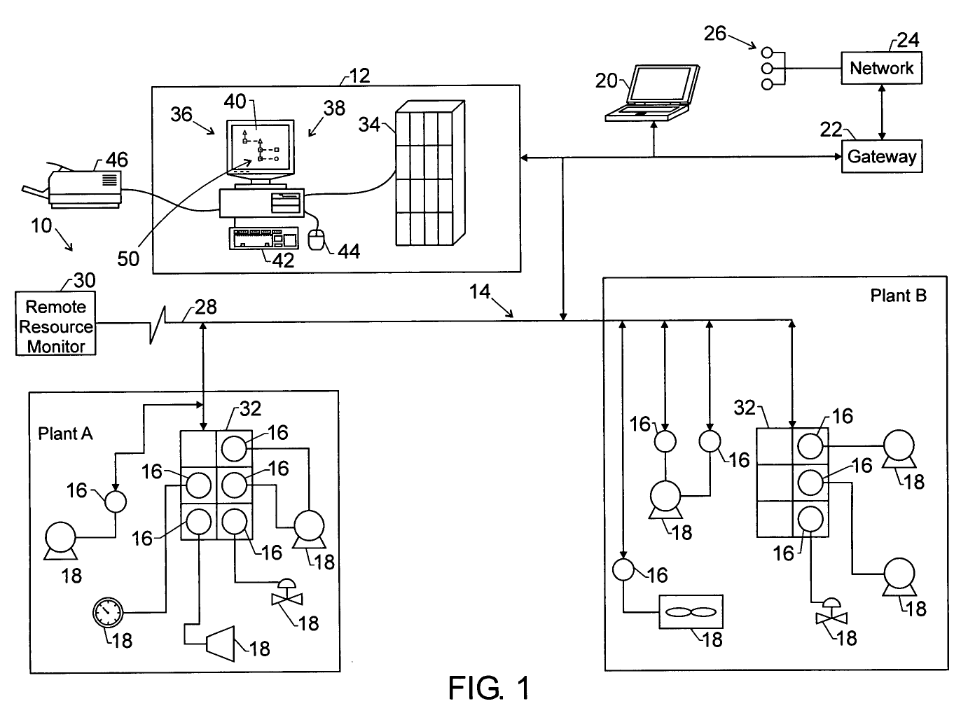

FIG. 1 illustrates a control and monitoring system 10 in accordance with embodiments of the present invention. While the control and monitoring system 10 may take many different forms and include many different components, the illustrated embodiment is provided to demonstrate certain aspects relating to the present invention. Specifically, as illustrated, the control and monitoring system 10 comprises a process manager 12 that utilizes a network 14 to access, monitor and control components 16 associated with equipment 18 within two plants (Plant A and Plant B). While two plants are illustrated in FIG. 1, one of ordinary skill in the art will recognize that a single plant or a plurality of plants may be used with embodiments of the present invention. In some embodiments of the present invention, a plant may not be designated at all.

Similarly, network 14 may represent multiple networks and permit data exchange with additional monitoring and control stations. For example, in the illustrated embodiment, a field engineer laptop 20 may be coupled to network 14 to produce representations of the system, monitor parameters sensed or controlled by the system, program components of the system, and so forth. Similarly, one or more gateways 22 may be provided which link network 14 to other networks 24. Such networks may use a similar or completely different protocol from that of network 14. The other networks 24 may include various remote devices, as indicated generally by reference numeral 26, which permit remote monitoring and control of devices in the system. One or more of the control or monitoring stations in the system may be adapted to be linked to outside elements by wide area networks, as represented generally at reference numeral 28, including the Internet. Thus, for example, laptop 20 may access remote resources and monitoring equipment 30 via wide area network 28.

It should be noted that, while reference is made herein to a wide area network 28, other network strategies may be implemented in the system, including virtual private networks, dedicated communications links, and so forth. While any suitable network may be used in the system, in a present embodiment, an industry standard network 14 is employed, referred to commonly under the name DeviceNet. Such networks permit the exchange of data in accordance with a predefined protocol, and may provide power for operation of networked elements.

Each plant (i.e., Plant A and Plant B) in the illustrated embodiment comprises multiple components 16 and associated equipment 18. The components 16 may include motor starters, motor controllers, variable frequency drives, relays, protective instruments such as circuit breakers, programmable logic controllers, temperature modules, pressure modules, and so forth. These components 16 may be physically located in a component assembly 32 (e.g., motor control center), on an associated device 18 (e.g., pump, fan, compressor, temperature element), or at some other designated location. Each component 16 may communicate directly or indirectly with one or more process managers 12 in the control and monitoring system 10 through the network 14. The process manager 12 in the illustrated embodiment comprises a system controller 34 (e.g., a distributed control system, a programmable logic controller) and a work station 36. The system controller 34 may be defined by various devices and may comprise computer systems connected to the components 16 via network 14. System controller 34 may store programs, routines, control logic, and the like for regulating operation of the components 16 of the system and may represent a node on the network 14.

In the illustrated embodiment, work station 36 includes a computer console 38 in which various types of memory supports may be employed, such as magnetic or optical memory devices (e.g., CD ROM's). The illustrated computer console 38 may be adapted to cooperate with peripheral devices, such as conventional computer monitor 40, and input devices such as a keyboard 42 and mouse 44. Moreover, the console 38 may cooperate with additional peripheral devices, such as a printer 46 for producing hard-copy reports. Work station 36 may be local to or separate from system controller 34. The work station 36 permits operational status and parameters to be monitored in real time, and affords programming of certain of the components 16 that are configurable. For example, the work station 36 may be used to calibrate a temperature indicator or to program an alarm setting. It should be noted that while a single work station 36 is illustrated in the figure, the process manager 12 may include a range of work stations 36, each located near one another or remote from one another in a particular application, interconnected with system controller 34 via the network 14 and each representing nodes on the network 14.

The work station 36 is adapted to display a system view 50 in accordance with embodiments of the present invention. As discussed above, a typical system view may be described as a graphical interface that provides a user with information relating to a networked system through a graphical display. Specifically, the work station 36 is adapted to display the system view 50, which facilitates rapid and efficient access to networked component characteristics in accordance with embodiments of the present invention. Additionally, the work station 36 may facilitate building and revising of the system view 50 and other system views. A plurality of system views 50 may be displayed on the monitor 40 at once or a plurality of system views 50 may be configured for display, where the monitor 40 displays one system view at a time. For example, a user may observe process metrics relating to Plant A on a particular system view 50 designed for Plant A and then cycle to a different system view 50 designed for Plant B to observe related metrics.

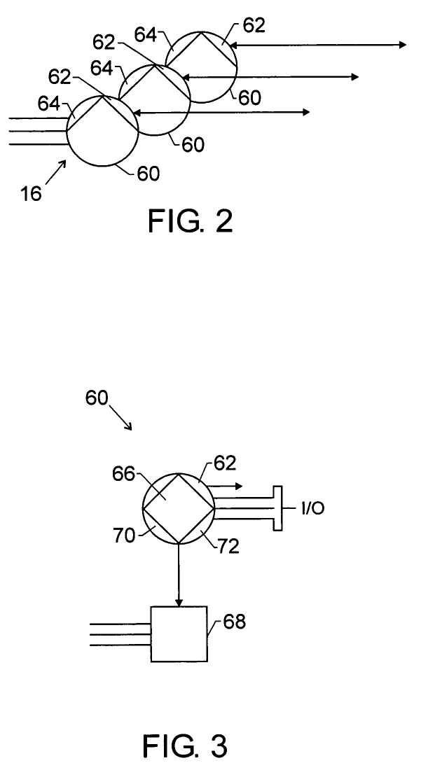

FIG. 2 is a block diagram illustrating various components 16 in accordance with embodiments of the present techniques. Components 16 generally include both an operative device, designated generally by the numeral 60, along with network interface circuitry 62, and load-line interface circuitry 64. While reference is made herein, generically, to a component 16, it should be noted that in an industrial automation context, such devices may include any or all of the power regulation devices mentioned above, process regulation or alarm devices, and so forth. In general, the devices may serve to regulate any useful industrial process or load, and may be configured to function in cooperation with one another, such as to protect process equipment from undesirable process conditions, and to protect the other components from overcurrent conditions, loss of phase, ground fault, or any other abnormal or unwanted condition. In normal operation, the devices function in accordance with a predetermined routine or program, either stored within the devices themselves, in memory of a programmable logic controller, or in memory of a system controller 34. Moreover, operation of the devices may be regulated in accordance with parameters sensed by the components themselves, or by system sensors. Finally, operation of the devices may be regulated by operator-induced command inputs, including inputs made via a computer interface (e.g., system view 50), push buttons, switches, or in any other suitable manner.

FIG. 3 is a block diagram illustrating an exemplary component 16 in accordance with embodiments of the present invention. Components 16, such as the one illustrated in FIG. 3, may be configured for direct connection to the data network 14, or may require connection to the network through a translator 66. In the illustrated embodiment to FIG. 3, translator 66 serves to communicate data to and from a downstream device 68, which is not equipped for directly receiving and transmitting data via the network. The components, in some embodiments of the present invention, include dedicated memory objects, which facilitate certain of the monitoring and control functions of the system. Where a downstream device 68 does not include such objects, or is not equipped for data communications in accordance with the network protocol, a translator 66 may, instead, include the necessary memory objects, and serve to take on the identity of the downstream object from the point of view of the data network, translating data from the device in accordance with a second protocol as defined by the device, such as a CAN protocol known as SCANport. In such cases, the translator 66 includes a device interface 70, which communicates with the downstream device 68 in accordance with the second protocol. Translator 66 may further include input/output interface circuitry 72 for transmitting and receiving information with other devices of the system. While not specifically illustrated, certain of the components 16 may include similar input and output interface circuitry, permitting them to similarly exchange information with external devices of the system.

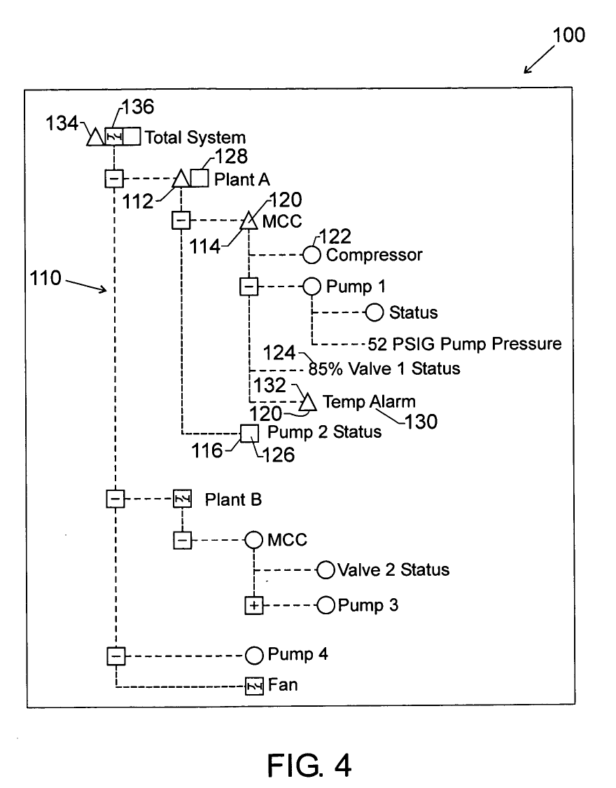

FIG. 4 illustrates a control and monitoring system view 100 in accordance with embodiments of the present techniques. The system view 100 may be adapted for monitoring component characteristics (e.g., run status, temperature, alarm status, flow) such as those of components 16 in the control and monitoring system 10. In some embodiments of the present techniques, the system view 100 may also provide access to configurable components and serve as an instrument for management of such components. For example, a user may use elements of system view 100 to change the set point of a controller, power down a motor, or rearrange graphic items (e.g., icons) in the system view relating to system components.

Specifically, system view 100, as illustrated, comprises an expandable component tree 110 that represents various network devices and components. The expandable component tree 110 may look and perform like a conventional element tree, but has features not available in existing interfaces of this type. Indeed, component icons in accordance with the present techniques have parent component icons that are expandable to reveal associated child component icons. For example, component icon 112 may be a parent icon of icons 114 and 116. Additionally, the component icons (e.g., 112, 114, and 116) may comprise dynamic component graphics that are linked or mapped to parameters in a database of component characteristics (e.g., a database of information acquired from a component 16). Further, component graphics (e.g., component graphics 120, 122, 124, and 126) may illustrate dynamic characteristics associated with each component or set of components represented by component icons in system view 100 in near real time. Further, each component icon may be programmable. For example, a user may configure a component icon to change its associated graphic based on a discrete component characteristic (e.g., change from a circle to a triangle based on the run status of a pump) or change its associated graphic corresponding to a continuous component characteristic (e.g., change color or actually illustrate a value based on the percentage of valve closure). In one embodiment of the present techniques, the icon may be initially set up to illustrate changes associated with a respective component 16 based on hardware elements within the component 16.

The present techniques also contemplate that icons (e.g., 120, 122, 124, 126, and 128) may be configured to illustrate component characteristics that are “passed up” through the component tree to facilitate operator evaluation of a process, and that the process and manner in which this is done may also be user-selectable and programmable. For example, icon 122 may represent a compressor run status by changing from a green circle during operation, to a yellow square during a warning phase, and to a red triangle during any of multiple failure scenarios (e.g., communication failure, operational failure). Such dynamic component icons, which are initially associated with particular graphics, may be passed up through the component tree 110 and associated with parent graphics in order to facilitate user detection and localization of a particular component status or value.

For example, in FIG. 4, the icon 120 may represent an alarm state designated as important to the overall system. Because a temperature value 130 in Plant A has reached this alarm state, a specific icon 132 for the associated device may reflect the component status by assuming the designated triangle graphic 120. Further, the associated triangle graphic 120 may be passed up the component tree 110 to each respective branch parent icon. For example, icon 114 in FIG. 4 may assume the same triangle graphic 120 as that of its child icon 132. This allows a user to expand out the component tree 110 in a logical fashion to determine from where the alarm state is originating. An operator viewing system view 100 would know that Plant A had an alarm because the Plant A parent icon 112 may comprise a triangle graphic 120. Upon expanding the Plant A parent icon 112, the operator would recognize that the alarm was emanating from the MCC parent icon 114.

This type of expansion of the component tree 110 might continue until the operator recognizes that the graphic 120 and thus the alarm state originated from icon 132 and its corresponding component 16. It should be noted that incorporation of various shapes and colors into the graphics may facilitate the avoidance of operator recognition problems (e.g., a colorblind operator may fail to notice a change from green to red). Additionally, it should be noted that a single icon may represent multiple data input scenarios (e.g., a red triangle representing multiple different failure scenarios).

In some embodiments of the present invention, specific techniques relating to passing graphics up a component tree (e.g., component tree 110) are user configurable. This may be desirable because specific component characteristics may be more important to an operator than other component characteristics. Indeed, certain status indicators may be redundant or their distinction may be unimportant to the operator. Programming may eliminate such distinctions, where desired. For example, to facilitate location of a failed component in the system view 100, an operator may want a failure status graphic (e.g., a red triangle) to pass up the component tree 110, while a run status graphic (e.g., a green circle) remains hidden or is merely displayed as a child icon. As a further example, for practical purposes, an indication of a component failure may be grouped with indications of loss of communications with the component (i.e., the response to both may be the same or similar). In such cases, similar changes to the icon may be made, despite actual differences in code reflected in the database on which icons are selected.

Determinations relating to which of a plurality of graphics pass up the component tree 110 may require a ranking system. Indeed, a ranking system may be necessary to prevent operator confusion resulting from each parent icon reflecting each of its child graphics and thus providing excessive graphical data. Accordingly, in some embodiments of the present invention, an operator may program the system view 100 to illustrate various graphic indicators based on a defined rank, wherein some indicators are designated as more important and some as less important. For example, a program logic step may indicate that if a first sibling component icon has a triangle graphic due to its associated component status while a second sibling component icon has a circle graphic due its associated component status, then the parent icon of both siblings should reflect the triangle graphic (e.g., IF sibling icon 1=triangle OR sibling icon 2=triangle, THEN parent icon=triangle).

It should be noted that one of ordinary skill in the art will recognize that such rankings may be based on component characteristics other than the associated graphic, including data directly obtained from particular components. Additionally, it should be noted that in some embodiments of the present invention, each parent icon directly mirrors a single graphic associated with its child icons, as determined by rank. In these embodiments, every graphic or illustrated characteristic would require a different rank or element for discernment. Alternatively, a parent icon may reflect multiple graphics (e.g., flash between a plurality of graphics) associated with a plurality of its child icons. For example, the main parent icon 134 in FIG. 4 comprises a graphic 136 that is illustrative of three different child graphics, each of which may have been given an equivalent rank.

FIGS. 4, 5, and 6 illustrate alternative system views in accordance with embodiments of the present invention. As discussed above, system views may comprise a plurality of different views including a process view, an equipment view, a network view, a combination view, and so forth. These different system views may comprise different icon arrangements and associations that are prearranged or user configured. For example, referring to FIG. 4, the system view 100 is an exemplary process view of control and monitoring system 10. The process view in FIG. 4 is arranged to illustrate a particular physical process layout, wherein each component icon (e.g., 112, 114, and 132) is located in relative correspondence to its physical location in the plant. Specifically, for example, icons associated with components 16 that are physically located in Plant A reside in the branch of tree 110 that is associated with the parent icon for Plant A, including a sub-branch of icons representing components stored in the MCC for Plant A.

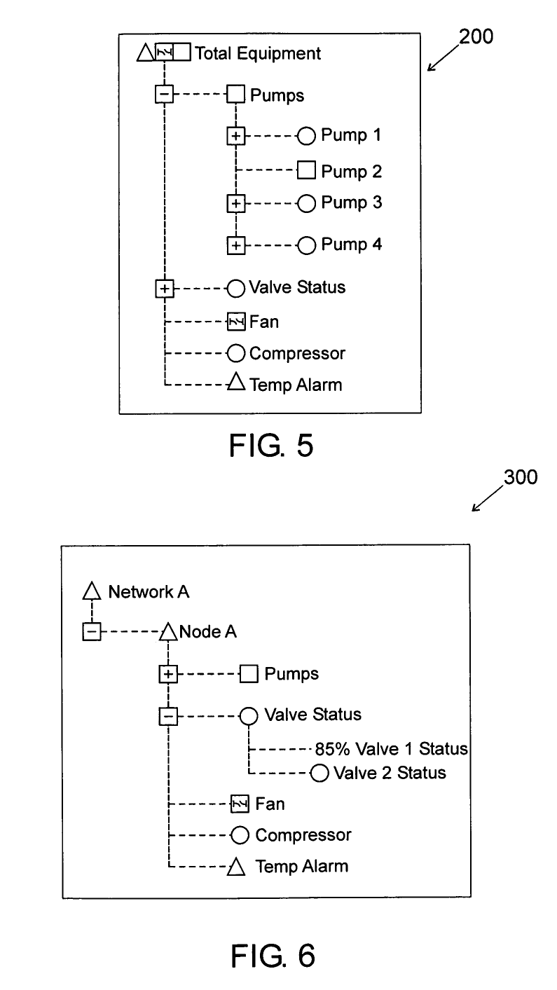

Similarly, FIG. 5 illustrates an equipment view 200 in accordance with embodiments of the present invention. In the equipment view 200, component icons may be arranged according to the equipment 18 with which each respective component 16 is associated. For example, the component icons are arranged by equipment type in equipment view 200 (e.g., all component icons relating to pumps are associated with the same pump parent icon). FIG. 6 illustrates a network view 300 in accordance with embodiments of the present invention. In the network view 300, component icons may be arranged according to network location (e.g., in relation to network nodes). Specifically, network view 300 combines a network view format with an equipment view format because branches from network Node A are based on associated equipment type.

It should be noted that the component trees in these system views may be configurable at installation or during operation. Some embodiments of the present invention allow for configuration using standard tools such as cut, copy, paste, rename, insert, drag-and-drop, and so forth. Such features may be useful in reconfiguring a system view to reflect process changes, the addition of new components, and so forth. In some embodiments of the present invention, a system view may be generated using data stored within the individual components, which may be polled by a monitoring station (e.g., system controller 34). The data may facilitate identification of the respective component, a physical disposition of the component in the system, equipment associated with the components, and/or network information relating to the component. Based upon the data, the monitoring station may build a system view including the identified component information. For example a plurality of system views (e.g., a process view, an equipment view, and a network view) may be automatically generated based on data stored in individual components. Additionally, graphics may be incorporated that reflect approximately accurate physical representations and operational characteristics of the individual components with identifying labels, facilitating monitoring and servicing of the components.

Where available, the various icons may be linked to additional information not specifically illustrated in the figures. For example, information pertaining to particular components, their settings, their status and so forth may be available by selecting a particular icon on any one of the views discussed above. The selection of the icon (or a selection from a drop-down menu or other graphic tool) may cause the system to load and display pages corresponding to catalog documentation, for example, error logs, event logs, physical views of the component (i.e., for location by service personnel), configuration pages and views and so forth. Indeed, the various views discussed above may constitute a configurable “starting place” for troubleshooting the entire networked system, or a portion of the system. The ability to create and change the views, then, and to provide links to information relating to the reasons for a change in status provide powerful tools for quickly and effectively analyzing and locating potential problems or otherwise addressable events. Such views and an exemplary manner in which they may be linked for viewing are described in greater detail in Caspers et at. (U.S. Pat. No. 6,651,110) entitled “Configurable Object for Industrial Control and Monitoring Networks,” which is hereby incorporated fully into the present description by reference.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system viewing tool for a networked system, comprising:
an expandable component tree, the component tree comprising at least one parent icon and at least one child icon, wherein the parent icon is expandable to reveal the child icon and the child icon is associated with a networked component of the networked system;
a first dynamic graphic associated with the child icon, wherein the first dynamic graphic is adapted to change based on changes relating to a status of the networked component; and
a sorting system adapted to pass the first dynamic graphic up the expandable component tree based on a configuration of the sorting system, to a second dynamic graphic associated with the parent icon.

2. The system viewing tool of claim 1, wherein the child icon is a second parent icon for a second child icon.

3. The system viewing tool of claim 1, wherein the sorting system is adapted for configuration by a user to sort according to a user defined ranking.

4. The system viewing tool of claim 1, wherein the networked component is adapted to associate itself with the expandable component tree by providing information relating to a location of the networked component relative to other networked components.

5. The system viewing tool of claim 1, wherein the system view is adapted to illustrate a plurality of organizational views.

6. The system viewing tool of claim 5, wherein the plurality of organizational views comprise a process view, an equipment view, and a network view.

7. The system viewing tool of claim 1, comprising a plurality of parent and child icons and corresponding dynamic graphics mapped to corresponding data in a database of component characteristics.

8. The system viewing tool of claim 1, comprising a functional graphic accessible from the expandable component tree, the functional graphic adapted to facilitate interaction with the networked component.

9. The system viewing tool of claim 8, wherein the functional graphic facilitates changing a set point on a controller.

10. The system viewing tool of claim 1, wherein the sorting system is adapted to pass the first dynamic graphic up the expandable component tree to the second dynamic graphic associated with the parent icon by replacing the second dynamic graphic.

11. The system viewing tool of claim 1, wherein the sorting system is adapted to pass the first dynamic graphic up the expandable component tree to the second dynamic graphic associated with the parent icon by combining the first dynamic graphic with the second dynamic graphic to form a third dynamic graphic.

12. The system viewing tool of claim 1, wherein the parent and child icons are adapted for graphical rearrangement by a user.

13. The system viewing tool of claim 1, wherein the expandable component tree is adapted for configuration using standard configuration tools.

14. The system viewing tool of claim 13, wherein the expandable component tree is adapted for configuration using a drag-and-drop tool.

15. A control and monitoring system, comprising:
a plurality of networked components;
a process manager having a console adapted to display a system view, the system viewing tool comprising:
an expandable component tree, the component tree comprising at least one parent icon and at least one child icon, wherein the parent icon is expandable to reveal the child icon and the child icon is associated with a one of the plurality of networked components;
a first dynamic graphic associated with the child icon, wherein the first dynamic graphic is adapted to change based on changes relating to a status of the one of the plurality of networked components; and
a sorting system adapted to pass the first dynamic graphic up the expandable component tree based on a configuration of the sorting system, to a second dynamic graphic associated with the parent icon.

16. The control and monitoring system of claim 15, wherein the child icon is a second parent icon for a second child icon.

17. The control and monitoring system of claim 15, wherein the sorting system is adapted for configuration by a user to sort according to a user defined ranking.

18. The control and monitoring system of claim 15, wherein the one of the plurality of networked components is adapted to associate itself with the expandable component tree by providing information relating to a location of the one of the plurality of networked components relative to the plurality of networked components.

19. The control and monitoring system of claim 15, wherein the system view is adapted to illustrate a plurality of organizational views.

20. The control and monitoring system of claim 15, comprising a functional graphic accessible from the expandable component tree, the functional graphic adapted to facilitate interaction with the one of the plurality of networked components.

21. The control and monitoring system of claim 15, wherein the sorting system is adapted to pass the first dynamic graphic up the expandable component tree to the second dynamic graphic associated with the parent icon by replacing the second dynamic graphic.

22. A control and monitoring system, comprising:
means for networking a plurality of network components;
means for displaying a system viewing tool, the system viewing tool comprising:
an expandable component tree, the component tree comprising at least one parent icon and at least one child icon, wherein the parent icon is expandable to reveal the child icon and the child icon is associated with a one of the plurality of networked components;
a first dynamic graphic associated with the child icon, wherein the first dynamic graphic is adapted to change based on changes relating to a status of the one of the plurality of networked components; and
means for passing the first dynamic graphic up the expandable component tree based on a configuration, to a second dynamic graphic associated with the parent icon.

23. A system viewing tool for a networked system, comprising:
an expandable component tree, the component tree comprising at least one parent icon and at least one child icon, wherein the parent icon is expandable to reveal the child icon and the child icon is associated with a networked component of the networked system;
a first dynamic graphic associated with the child icon, wherein the first dynamic graphic is adapted to change to represent a plurality of states of the networked component in a user configurable manner; and
a sorting system adapted permit programming of the user configurable manner and to pass the first dynamic graphic up the expandable component tree based on the user configured manner, to a second dynamic graphic associated with the parent icon.

24. The system viewing tool of claim 23, wherein the sorting system is configurable to represent a plurality of different states of the networked component by a single dynamic graphic.

25. The system viewing tool of claim 23, wherein the plurality of states include a run state, a failure state and a loss of communications state.

26. The system viewing tool of claim 23, wherein the first dynamic graphic is associated with the child icon via a database containing operational data for the networked component.

27. The system viewing tool of claim 23, wherein the child icon is linked to at least one additional view for representing operational details for the networked component.

28. The system viewing tool of claim 27, wherein the at least one additional view includes an error log.

29. The system viewing tool of claim 27, wherein the at least one additional view includes a configuration page for the networked component.
